(19) United States
(12) Patent Application Publication
(10) Pub. No.: US 2009/0300201 A1
(43) Pub. Date: Dec. 3, 2009

(54) Method for Sending a Media Data Stream and Method for Receiving and Creating a Reconstructed Media Data Stream, and Associated Transmission Apparatus and Receiption Apparatus

(75) Inventors: Peter Amon, Munchen (DE); Uwe Rauschenbach, Poing (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munchen (DE)

(21) Appl. No.: 11/988,438

(22) PCT Filed: Jun. 30, 2006
(86) PCT No.: PCT/EP2006/063728

§ 371 Date: Aug. 7, 2009

(30) Foreign Application Priority Data
Jul. 8, 2005 (DE) 10 2005 032 080.5

(51) Int. Cl. H04B 1/66; G06F 15/16

(52) U.S. Cl. 709/231

(57) ABSTRACT

A method sends a media data stream in which encoding of the media data stream generates a first data stream and at least one second data stream such that the first data stream represents the media data stream in a basic quality and one or more second data streams together with the first data stream represent the media data stream in an improved quality over the basic quality, in which data in the first and second data streams are respectively sent using a transmission channel allocated in predefined fashion. Another method receives and creates a reconstructed media data stream, in which the reconstructed media data stream is reconstructed from a first data stream or from the first and at least one second data stream, in which data from the first data stream or from the first and at least one second data stream are received in a respective transmission channel allocated in predefined fashion, where the reconstructed media data stream is generated by decoding the data in the first data stream or by decoding the data in the first and at least one second data stream.

### CROSS REFERENCE TO RELATED APPLICATIONS

This application is based on and hereby claims priority to German Application No. 10 2005 032 080.5 filed on Jul. 8, 2005 and PCT/EP2006/063728 filed on Jun. 30, 2006, the contents of which are hereby incorporated by reference.

### BACKGROUND OF THE INVENTION

In many applications different qualities of media data stream, e.g. video data streams or audio streams are required. For example a mobile telephone is only in a position to reproduce the video data stream with a low image resolution, e.g. 176×144 pixels. On the other hand mobile computers, such as a tablet PC for example, can display the video data stream at up to 1280×768 pixels.

### SUMMARY

One potential object is to specify a method and an apparatus which allows the transmission or reception of a media data stream for receiving terminals with different device characteristics in a simple and cost-effective manner.

The inventors propose a method for sending a media data stream in which a first data stream and at least one second data stream are generated by an encoding of the media data stream such that the first data stream represents the media data stream in a basic quality and one or more second data streams together with the first data stream represent the media data stream in an improved quality compared to the basic quality. Data of the first and the second data streams is sent in each case in a predefined assigned transmission channel.

The proposed method makes it possible for distribution services, e.g. streaming services or broadcasting services, to offer to terminals with different device functionalities media data streams such that these can be received, processed and reproduced. The method also allows a resource-efficient application in a terminal, since only those transmission channels need be received which can or should be processed by the terminal. This enables both power consumption to be reduced or the operating life of the terminal to be increased respectively, and also complexity in the processing of the received data of the transmission channels to be reduced.

If the data of the first and/or the second data stream is preferably generated using a compression method, with digital data in particular being generated by the compression, a volume of data to be transmitted can be reduced. Furthermore standardized encoding methods can be used as compression methods, allowing a low-cost implementation to be realized.

In a variant of the method the first and the second data streams are preferably generated such that they exhibit a respective data rate depending on a bandwidth of the respective transmission channel.

This enables the data rate of the data streams to be adapted to the bandwidth of the respective transmission channel during encoding, which allows an efficient utilization of the transmission channels to be achieved.

In a method for receiving and creating a reconstructed media data stream, data of the first data stream or of the first and at least one second data stream is received in a predefined assigned transmission channel in each case, with the first data stream representing the media data stream in a basic quality and one or more second data streams together with the first data stream representing the media data stream in an improved quality compared to the basic quality, and the reconstructed media data stream being generated by decoding the data of the first data stream or by decoding the data of the first and at least one second data stream.

With the aid of the method for reception it is made possible for a terminal to create the reconstructed media data stream using the first and optionally one or more second data streams. In this case the method allows a resource-efficient use in a terminal, since only those transmission channels need be received which can or should be processed by the terminal. This enables both power consumption to be reduced or the operating life of the terminal to be increased respectively, and also complexity in the processing of the received data of the transmission channels to be reduced.

If a plurality of transmission channels of the second data streams to be received in addition to the transmission channel of the first data stream are preferably determined as a function of a control signal, a terminal can take account of more or fewer transmission channels of the second data streams during the creation of the reconstructed data stream, both as a function of its device functionality, e.g. reproduction properties of the device screen, and also of parameters which change over time, such as a variation in processing power for example.

If the control signal is also generated as a function of a capacity of a battery of a reception apparatus for executing the method, of a supported range of device functions of the reception apparatus, of a load on the reception apparatus and/or on the basis of a change in a transmission quality, both static and also dynamic individual characteristics of the terminal can be taken into account.

Preferably the transmission channels are each allocated time slots of a transmission method. This enables the transmission channels to be transferred in a simple manner, since a reception apparatus can recover the transmitted data of the transmission channels without great processing effort. Furthermore a receive unit only needs to be switched on during the transmission channels or time slots to be taken into account, which means that power consumption is reduced by comparison with continuous reception.

In a further variant subcarriers of a modulation method are assigned to the transmission channels so that the individual transmission channels are able to be separated as part of a demodulation method associated with the modulation method. This enables a reduction of the computing effort to be achieved since only the subcarriers have to be processed which contain data which is used to create the reconstructed media data stream.

Preferably the transmission channels are each allocated a specific frequency band of a transmission method. This allows a simple and cost-effective separation of the transmission channels in the receiver apparatus to be achieved since only those frequencies have to be processed which include data which will be used for the creation of the reconstructed media data stream.

If, in a preferred expansion, at least two data streams comprising the first and at least one second data stream or at least two second data streams are assigned to a single transmission channel, sending the first and/or second data stream can be undertaken in an efficient manner. This is because a possible signaling overhead for the timeslots assigned to the transmission channels for example is reduced. Furthermore a complexity in a terminal can be reduced since fewer transmission channels to be taken into account are present.

The inventors also propose a transmission apparatus for sending a media data stream with an encoding module which is embodied so that, by encoding the media data stream, a first data stream and at least one second data stream are generated such that the first data stream represents the media data stream in a basic quality and one or more second data streams together with the first data stream represent the media data stream in an improved quality compared to the basic quality, and with a first assignment module which is embodied such that the data of the first and the second data streams is sent in a predefined assigned transmission channel in each case. The method for transmission can be implemented and executed with this transmission apparatus.

In addition the inventors propose a reception apparatus for receiving and creating a reconstructed media data stream, with a second assignment module which is embodied so that data from the first data stream or from the first and at least one second data stream is received in each case in a predefined assigned transmission channel, with the first data stream representing a media data stream in a basic quality and one or more second data streams together with the first data stream representing the media data stream in an improved quality compared to the basic quality, and with a decoding module which is embodied so that the reconstructed media data stream is generated by decoding the data of the first data stream or by decoding the data of the first and at least one second data stream. The proposed method for receiving can be implemented and executed with this reception apparatus.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 an exemplary embodiment of a transmission apparatus and a reception apparatus for executing the proposed method;

FIG. 2 an assignment of data of different data streams to a respective frequency band as a function of the time;

FIG. 3 a signal space and a code assignment when a 16-QAM method is used for assignment of data to different data streams;

FIG. 4A an exemplary embodiment of an assignment of data of different data streams when a 16-QAM method is used;

FIG. 4B an exemplary embodiment for recovery of data of different data streams when a 16-QAM method is used.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The proposed method for transmitting a media data stream M or for receiving and creating a reconstructed media data stream R is explained in greater detail with reference to a video distribution service. In this case a message transmission, comprising a video signal for example, is to be transmitted to two terminals, with these terminals having different device functionalities. The first terminal can only process a video signal with low image resolution, e.g. in QCIF=176×144 pixels (QCIF=Quarter Common Intermediate Format), at a low image refresh rate, e.g. 15 fps (fps=frames per second). By contrast the second terminal is capable of receiving, processing and displaying a video signal at high image resolution, e.g. in CIF=352×288 pixels (CIF=Common Intermediate Format), at a low image refresh rate, e.g. 15 fps.

The message transmission in the form of a video signal thus represents one possible type of a media data stream M. Other types of a media data stream M are for example a still image, a speech signal, a piece of music or a data record which is able be presented at a plurality of quality levels. For this exemplary embodiment it is typically assumed that the media data stream M includes a sequence of unencoded images with a frame rate of 30 fps and CIF image resolution, with each pixel being represented by a triple with the colors red, green and blue. Alternatively each pixel can be formed from a combination of a brightness value (=luminance) and two color values (=chrominance).

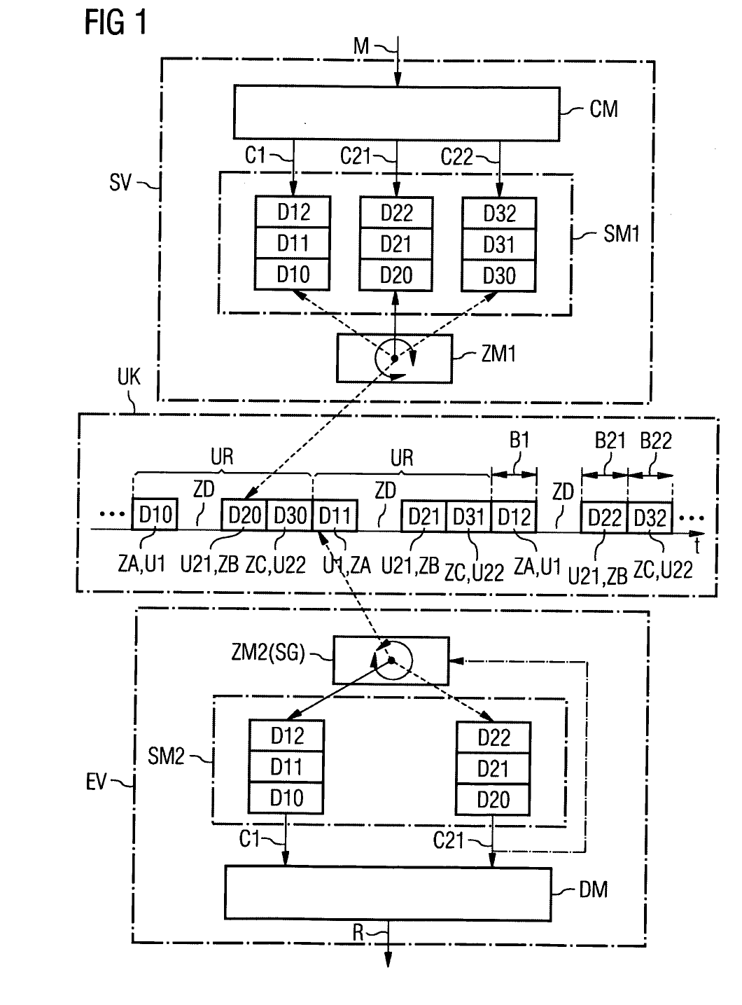

The media data stream M is subsequently fed image-by-image to an encoding module CM of a transmission apparatus SV. This can be seen in FIG. 1. The encoding module CM is embodied so that it creates or encodes one or more data streams C1, C21, C22 which make it possible to scale the media data stream M. Scaling in this context means that, the more data streams are taken into account in the reconstruction of the media data stream M, i.e. in a decoding of the data streams, the better is the quality of a reconstructed media data stream R. In general the following two kinds of scaling type can be distinguished:

Layer Model

In this case the data streams are organized hierarchically such that the data streams build on one another. Using the first data stream C1 as the starting point, with said data stream also being referred to as the basic layer, by successive addition of an expansion layer, e.g. the second data stream C21, the aim is to improve the quality, in respect of image resolution and the image refresh rate for example. Building on this, by inclusion of an additional expansion layer, e.g. of the second data stream C22, an additional improvement in respect of image refresh rate can be achieved. This means that with a layer model a fixed sequence for the inclusion of the individual layers is predetermined.

Class Model:

In this case the data streams are organized into classes. The first data stream C1 corresponds to a basic class and each of the second data streams C21, C22 represents one of the expansion classes. By adding an expansion class to a set of classes including the basic class an improvement in quality is achieved in one dimension, e.g. in respect of image refresh rate or image resolution. The use of classes makes possible a more flexible selection of the quality levels than does the use of layers, since, building on the basic class, one or more expansion classes can be combined with more degrees of freedom.

In the present exemplary embodiment three data streams C1, C21, C22 will be generated using the layer model. The first data stream C1 in this case represents the basic layer with an image resolution in QCIF and the image refresh rate of 15 fps. The second data stream C21 represents a first expansion layer which allows a reconstruction of the media data stream M with an image resolution in CIF and with the image refresh rate of 15 fps. A second expansion layer is represented by the second data stream C22 which makes possible a reconstruction with an image resolution in 4CIF (4CIF=four times Common Interchange Format, 704×576 pixels) with an image refresh rate of 30 fps. The first and the second data streams C1, C21, C22 can be encoded or compressed in accordance with a video compression standard e.g. according to H.264, MPEG4FGS (MPEG—Motion Picture Expert Group; FGS—Fine Granular Scalable Coding) or in accordance with the SVC (SVC—Scalable Video Coding) standard now being standardized. Furthermore encoding can be undertaken digitally, with encoded data of the first or of the second data stream C1, C21, C22 featuring binary symbols.

Furthermore the first and the second data streams C1, C21, C22 can be organized and stored in a first storage module SM1. Individual encoded data packets D10, . . . , D32 of the first and the respective second data streams C1, C21, C22 in this case represent data for a video image or a group of video images respectively for example. Thus for example, for a first video image, data of the first data stream C1 is contained in the encoded data packet D10 and data of the second data stream C21 or C22 is contained in the coded data packet D20 or D30. The data of a second video image can be found in the coded data packets D11, D21 and D31. The data of a further video image typically represents the coded data packets D12, D22 and D32.

In a subsequent processing step the first and second data streams C1, C21, C22 are each transmitted in a predefined assigned transmission channel U1, U21, U22. The encoded data packets of the first and the second data streams C, C21, C22 can each be assigned to a respective transmission channel U1, U21, U22 with the aid of an assignment specification. An assignment specification of this type is as shown below for example:

| Data stream | transmission channel |
|---|---|
| C1 | U1 |
| C21 | U21 |
| C22 | U22 |

The transmission channels U1, U21, U22 are assigned to a physical transmission medium such that a unique recovery of the transmission channels U1, U21, U22 at a reception apparatus EV is made possible. This is shown in greater detail on the basis of a time slot-oriented transmission method UK. This transmission method UK defines individual time slots ZA, . . . , ZD. The individual time slots ZA, . . . , ZD can be organized into frames UR, with the frames UR being able to be repeated. In this exemplary embodiment the following assignment between transmission channel and time slot is assumed:

| Time slot | Transmission channel |
|---|---|
| ZA | U1 |
| ZB | U21 |
| ZC | U22 |

Using a first assignment module ZM1 the encoded data packets D10, . . . , D31 of the first or the second data streams C1, C21, C22 are allocated by means of the assignment of the associated transmission channel U1, U21, U22 to the respective time slot ZA, ZB, ZC assigned to the transmission channel U1, U21, U22 frame-by-frame. The result of this assignment is to be seen in FIG. 1. Furthermore the encoded data packets D10, . . . , D32 are transmitted from the transmission apparatus SV to the reception apparatus EV with the aid of the transmission method UK. This can typically be undertaken with the aid of a DVB (DVB—Digital Video Broadcast) network or an ISDN (ISDN—Integrated Services Digital Network) network. Using the time slot ZD as an example, FIG. 1 further shows that data does not have to be transmitted in all time slots.

The reception apparatus EV receives the encoded data packets D10, . . . , D32, with the assignment of time slots ZA, . . . , ZD to transmission channels U1, . . . , U21 and of transmission channels U1, . . . , U21 to data streams C1, . . . , C22 being made possible on the basis of the assignments given above. This assignment is made with the aid of a second assignment module ZM2 in the reception apparatus EV. It should be noted in this case however that, depending on the device functionality of the terminal, in which the reception device EV is located, not all transmission channels need be taken into account in the assignment. For example only those transmission channels are read out which contain data of the data streams to be taken into consideration.

In the present exemplary embodiment the reconstructed media data stream R is to be generated for the second terminal so that it supports the frame rate of 15 fps and the image resolution of CIF. This is because the second terminal includes a device functionality which typically supports these image parameters, i.e. frame rate of 15 fps. A higher frame rate is typically not possible for reasons of complexity or because of an output medium which can reproduce a maximum of 15 fps. The reconstructed media data stream R can be created by the first data stream C1 and the second data stream C21. To read out the data assigned to these data streams C1, C21, i.e. the encoded data packets, D10, . . . , D22, the second assignment module ZM2 merely selects the two transmission channels U1, U21 to receive the required data. The transmission channel U22 is not taken into account in this case. The encoded data packets D10, . . . , D22 received from the transmission channels U1, U21 can be organized and stored in a second storage module SM2.

The data, i.e. the encoded data packets D10, . . . , D22 of the first and second data stream C1, C21 is subsequently transferred to a decoder module DM which creates individual video images from this data. For example a first video image can be reconstructed by decoding the encoded data packets D10, D20. The reconstructed video images produce the reconstructed media data stream R. This reconstructed media data stream R possibly exhibits a lower image quality than the media data stream M, since the data of all data streams C1, C21, C22 has not been taken into account in the reconstruction, i.e. the decoding. Furthermore, because of a compression which may possibly have been carried out, encoding pulses occur which give rise to a reduced image quality in relation to the media data stream M.

The reconstructed media data stream R can be output on an output medium, for example a screen, and/or be stored in a further storage module for subsequent further processing.

By comparison with the procedure for reconstruction of the reconstructed media data stream R for the second terminal, when the first terminal is used only the data, i.e. the encoded data packets D10, . . . , D12, of the first data stream C1 is used, since the data of the second data streams C21, C22 cannot be processed by the first terminal. The second assignment module ZM2 thus only reads the transmission channels U1 and decodes the data of the first data stream C1. This decoding creates a reconstructed media data stream R representing the image refresh rate of 15 fps and a QCIF image resolution.

The control of the second assignment module ZM2 can be effected with the aid of a control signal SG, with the control signal SG being formed as a function of the device functionalities available in the terminal so that only those transmission channels are taken into account which correspond to the device functions. Furthermore a reduction of the transmission channels to be taken into account can be undertaken by a user with the aid of a user control. In addition or as an alternative the transmission channels to be taken into account can be selected as a function of display options of a screen, a capacity of a battery of a reception apparatus or also as a function of a load on a reception apparatus. The two last-mentioned dependencies make possible an efficient use of resources in the method for receiving, since the operating life of the reception apparatus can be increased with reduced capacity and/or loading by reduction of the transmission channels to be read.

Thus the proposed method for transmission or the proposed method for reception makes it possible for terminals with different device functionalities to receive and reproduce different media content such as a message transmission or a piece of music for example. In this case it is especially advantageous that, in addition to simple handling during readout of one or more transmission channels, a complexity required for receiving and reconstruction increases or decreases depending on the transmission channels read out. The fewer transmission channels are taken into account, the lower is the complexity. A reduction in the complexity can be reflected in a lower-cost implementation, e.g. hardware components, and in a reduced power consumption. Since the respective assignment of the data streams C1, C12, C22 to the transmission channels U1, U21, U22 is predefined, a constant “listening-in” on all transmission channels is not necessary. Thus the power consumption can be additionally reduced by an assignment of the data, i.e. encoded data packets, only having to be undertaken when the transmission channels U1, U21, U22 to be taken into account are active. Otherwise for example a receive module (not identified) of the reception apparatus which controls a physical reception of the transmission channels can be separated from the power supply.

Variants and expansions of the method for transmission or of the method for reception are explained in greater detail below.

The time slots ZA, . . . , ZD can have a fixed duration or different durations. Depending on a data rate of the timeslot-oriented transmission method UK, these time slots ZA, . . . , ZD can include a fixed or variable number of data units, e.g. measured in bytes Thus for example the time slot ZA comprises 100 bytes and time slot ZB comprises 50 bytes. From frame UR to frame UR the time slots ZA, . . . , ZD can accommodate an equal maximum number of data units, whereas the data of data streams C1, C21, C21 from frame UR to frame UR can include a fixed or a varying number of data units in the time slots ZA, . . . , ZD.

In an expansion the data of a data stream, e.g. of the first data stream C1, can be sent and received divided up on at least two transmission channels.

In an alternate expansion of the method for transmission, in the encoding or generation of the first and/or second data streams C1, C21, C22 a data rate belonging to the first and/or the second data stream C1, C21, C22 respectively can be determined as a function of a bandwidth B1, B21, B22 of the respective transmission channel U1, U21, U22. If for example an overall data transmission rate of the time-slot oriented transmission procedure UK is known, each time slot ZA, . . . , ZD can be assigned a bandwidth. If the overall transmission data rate of the timeslot-oriented transmission process UK e.g. is 100 kbyte/s, the bandwidth of the timeslot ZA or of the transmission channel U1 is calculated from a number of data units per time slot, e.g. 100 bytes, as a number of data units per frame UR, e.g. 500 bytes, and thus as

B1=100 kbyte/s*100 Byte/500 Byte=20 kbyte/s.

The encoding of the data streams C1, C21, C22 can thus be controlled as a function of the bandwidth B1, B21, B22 available per transmission channel U1, U21, U22. Thus in accordance with the above example, a rate control of the coding module CM, a maximum data rate for the first data stream C1 to B1=20 kbyte/s is created.

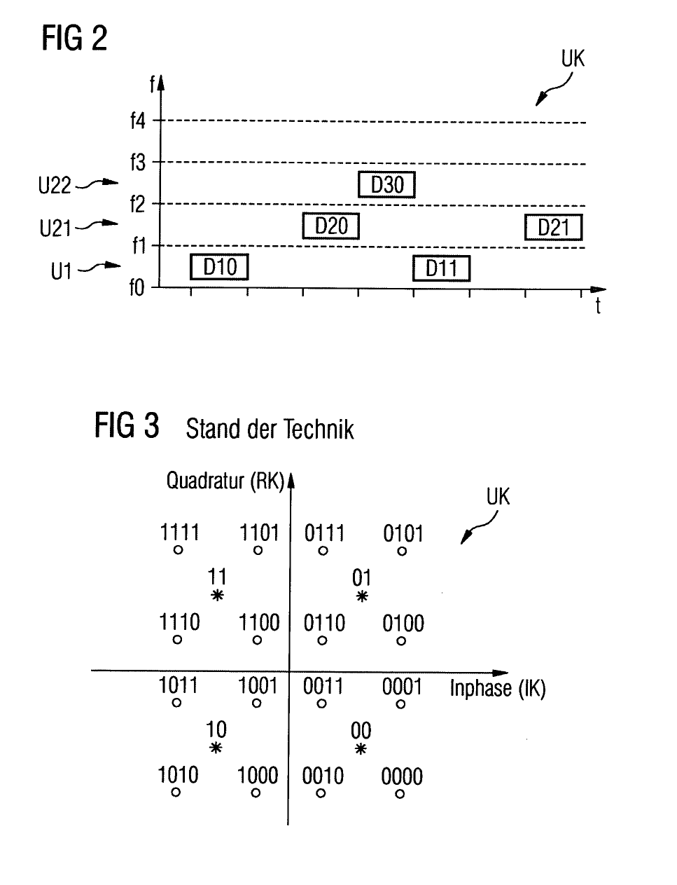

In an alternative or to supplement the use of the timeslot-oriented transmission method UK for sending the transmission channels, a frequency-based transmission method UK can also be used. This is shown in greater detail in FIG. 2. In this case the respective transmission channels U1, U21, U22 are transmitted within a respective frequency band FA, . . . , FC. Thus for example the transmission channel U21 is transferred in the frequency band FA, which lies between the frequencies f1 and f2. In this case the frequency bands FA, . . . , FC can have a bandwidth of 10 kHz for example. It can also be seen from FIG. 2 that the encoded data packets D10, D20, D30 are transmitted both in different frequency bands and also in different time slots. FIG. 2 thus represents a combined frequency and time slot-oriented transmission method UK. In addition there can be a modulation on a carrier frequency in this transmission method. The reference symbol UK is intended, to indicate any transmission method which makes possible a unique recovery of the transmission channels U1, U21, U22 at a reception apparatus EV.

Instead of use of the combined frequency- and timeslot-oriented transmission method UK a frequency-oriented only transmission method UK can also be used. In this case the transmission channels U1, U21, U22 are each assigned a frequency band FA, . . . , FC. The data of the respective data streams C1, C21, C22 is transmitted within the respective associated transmission channels U1, U21, U22 or within the frequency bands assigned thereto.

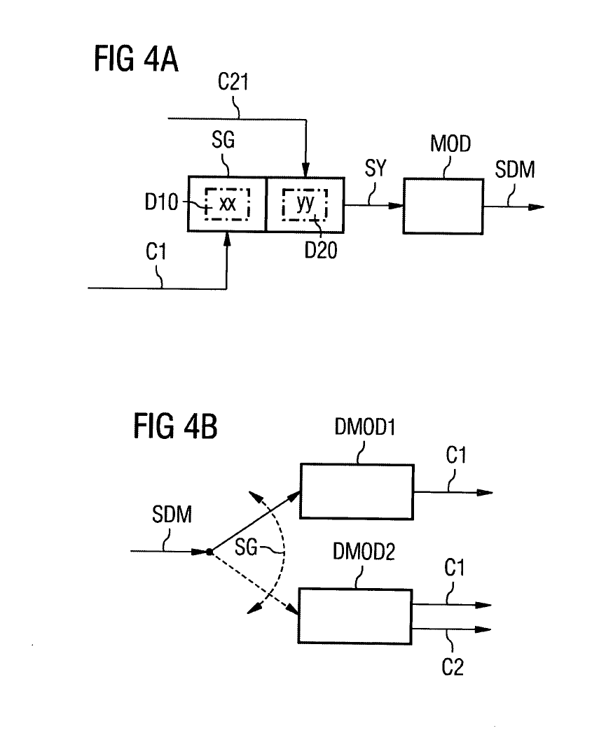

In an expansion of the method a modulation-oriented transmission method UK can be used. This is illustrated in more detail with reference to the FIGS. 3, 4A and 4B. If for example the encoded data packet D10 of the first transmission channel U1 includes the two symbols XX and the encoded data packet D20 of the second transmission channel U21 includes the symbols YY, by stringing together these symbols XX or YY by a symbol generator SG a combined symbol SY=YYXX can be generated, see FIG. 4A. The modulated signal SDM is created with the aid of a subsequent modulation by a modulation module MOD. If binary symbols, i.e. 0 or 1 are used for the symbols X or Y, then for a 16-QAM modulation (QAM—Quadrature Amplitude Modulation) the modulated signals can be found in the form of circles “o” in the IK-RK diagram (IK=Inphase Component; RK=Quadrature Component) in accordance with FIG. 3. This is known from the related art. Within the modulated signal SDM the data or data packets of the first data stream represent a first subcarrier and the data or data packets of the second data stream a second subcarrier. The subcarriers preferably build hierarchically on each other, as shown in FIG. 3.

In this example the 16-QAM method is used as the modulation method or demodulation method. Within the framework of this document, any method which makes possible a separation of a subcarrier of a modulation method within the framework of the associated demodulation method can be used, with each subcarrier representing one of the respective transmission channels.

In an alternate expansion of the method at least two data streams, comprising the first and at least one second data stream or at least two second data streams, are assigned to a single transmission channel.

For reconstruction of the reconstructed media data stream R a layout in accordance with FIG. 4B can be used in the reception apparatus EV. In this case the modulated signals SDM are received and by means of a selection switch which is controlled by the control signal SG, transferred to either a first demodulation module DMOD1 or to a second demodulation module DMOD2. The first demodulation module DMOD1 merely delivers data of the transmission channel U1, i.e. encoded data D10, . . . , D12 of the first data stream C1. This is identified in FIG. 3 with a “*” symbol. If on the other hand the data of the transmission channels U1 and U21, i.e. the encoded data D10, . . . , D12 of the first data stream C1 and the encoded data D20, . . . , D22 of the second data stream C21 is output, the modulated signals SDM are transferred to the second demodulation module DMOD2.

This variant for the modulation method UK has the advantage for example that, even with deteriorating transmission qualities, a receipt, e.g. the message transmission is enabled by only the first subcarrier or transmission channel U1 being taken into account for the reconstruction, since this transmission channel U1, because of the modulation-oriented transmission method UK, has a lower susceptibility to faults than the second subcarrier or the transmission channel U21. The control signal SG can thus also be triggered or formed as a function of a transmission quality Q. In this case for example the second data stream C21 is transferred to the second assignment module ZM2, which on the basis of a packet error rate of the encoded data packets D20, . . . , D22 creates a new control signal SG. If for example more than 30% of the encoded data packets D20, . . . , D22 are faulty, the control signal SG is modified such that only the encoded data packets D10, . . . , D12 of the first data stream C1 are taken into account for the reconstruction of the reconstructed media data stream R. This method of operation can achieve an increase in the image quality of the reconstructed media data stream R, since taking account of the faulty second data stream in the reconstruction can lead to disruptive image artifacts.

The transmission apparatus SV can be accommodated in a streaming server and/or broadcasting server. The streaming server operates in such cases for example according to the 3GPP-PSS standard (3GPP—3rd Generation Partnership Project; PSS—Packet-based Streaming Service) and the broadcasting sever operates according to the 3GPP-MBMS (MBMS—Multimedia Broadcast/Multicast Service) or the DCB-H Standard (DVB-H—Digital Video Broadcast—Handheld). The servers can be integrated into a UMTS-, GSM- and/or IP-based network (UMTS—Universal Mobile Telecommunications system; GSM—Global System for Mobile Communications; IP—Internet Protocol).

The reception apparatus EV can be integrated into a portable unit, especially a mobile telephone or a PDA (PDA—Personnel Digital Assistant), and/or a stationary device, especially a computer or fixed network telephone.

The transmission apparatus SV or the reception apparatus EV are for example realized with hardware components or a computer which is embodied so that the method for transmission or the method for reception and creation is made possible in software, or is realized from a combination of hardware and software.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method of sending a media data stream, comprising:
generating a first data stream and at least one second data stream by encoding the media data stream, the first data stream representing the media data stream having a basic quality, the at least one second data stream and the first data stream together representing the media data stream having an improved quality in comparison to the basic quality; and
sending data of the first and the at least one second data stream in a predefined assigned transmission channel, respectively.

14. The method as claimed in claim 13, wherein the data of the first data stream and/or the at least one second data stream is created using a compression method, digital data being generated by the compression method.

15. The method as claimed in claim 13, wherein the first data stream and the at least one second data stream are generated such that the first data stream and the at least one second data stream exhibit respective data rates as a function of a bandwidth of the respective transmission channel.

16. The method as claimed in claim 14, wherein the first data stream and the at least one second data stream are generated such that the first data stream and the at least one second data stream exhibit respective data rates as a function of a bandwidth of the respective transmission channel.

17. A method of receiving and creating a reconstructed media data stream, comprising:
receiving data of a first data stream or of the first data stream and at least one second data stream in a predefined assigned transmission channel, respectively, the first data stream representing the media data stream having a basic quality, the at least one second data stream and the first data stream together representing the media data stream having an improved quality in comparison to the basic quality; and
generating the reconstructed media data stream by decoding the data of the first data stream or by decoding the data of the first data stream and the at least one second data stream.

18. The method as claimed in claim 17, wherein a number of transmission channels of the at least one second data stream to be received in addition to the transmission channel of the first data stream are determined as a function of a control signal.

19. The method as claimed in claim 18, wherein the control signal is generated as a function of a capacity of a battery of a reception apparatus executing the method of receiving and creating a reconstructed media data stream, a function of a supported range of device functions of the reception apparatus, a function of a loading of the reception apparatus and/or based on a change in a transmission quality.

20. The method as claimed in claim 17, wherein the transmission channels are each assigned to time slots of a transmission method.

21. The method as claimed in claim 17, wherein the transmission channels are assigned to subcarriers of a modulation method such that the individual transmission channels are separable as part of a demodulation method associated with the modulation method.

22. The method as claimed in claim 17, wherein the transmission channels are each allocated a specific frequency band of a transmission method.

23. The method as claimed in claim 17, wherein at least two data streams including the first data stream and at least one second data stream or at least two second data streams are assigned to an individual transmission channel.

24. The method as claimed in claim 19, wherein the transmission channels are each assigned to time slots of a transmission method.

25. The method as claimed in claim 24, wherein the transmission channels are assigned to subcarriers of a modulation method such that the individual transmission channels are separable as part of a demodulation method associated with the modulation method.

26. The method as claimed in claim 25, wherein the transmission channels are each allocated a specific frequency band of a transmission method.

27. The method as claimed in claim 26, wherein at least two data streams including the first data stream and at least one second data stream or at least two second data streams are assigned to an individual transmission channel.

28. A transmission apparatus to send a media data stream, embodied to carry out a method of transmission, comprising:
an encoding module generating a first data stream and at least one second data stream, by encoding of the media data stream, the first data stream representing the media data stream having a basic quality, the at least one second data stream and the first data stream together representing the media data stream having an improved quality in comparison to the basic quality; and
an assignment module assigning data of the first data stream and the at least one second data stream to a predefined assigned transmission channel, respectively, such that the data of the first data stream and the at least one second data stream is transmitted in the predetermined assigned transmission channel.

29. A reception apparatus of receiving a reconstructed media data stream, embodied to carry out a method of receiving and creating a reconstructed data stream, comprising:
a second assignment module selecting a predefined assigned transmission channel such that data of a first data stream or data of the first data stream and at least one second data stream is respectively received in the predefined assigned transmission channel, the first data stream representing the media data stream having a basic quality and the at least one second data stream and the first data stream together representing the media data stream having an improved quality in comparison to the basic quality; and
a decoder module causing the reconstructed media data stream to be generated by decoding the data of the first data stream or by decoding the data of the first data stream and the at least one second data stream.
